(19) United States
(12) Patent Application Publication
(10) Pub. No.: US 2007/0138661 A1
(43) Pub. Date: Jun. 21, 2007

(54) GAS PERMEABLE LIQUID VESSEL

(75) Inventor: Joseph E. Sicari, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: PARAGON VISION SCIENCES, INC., Mesa, AZ (US)

(21) Appl. No.: 11/306,180

(22) Filed: Dec. 19, 2005

(51) Int. Cl. B01D 47/00

(52) U.S. Cl. 261/100

(57) ABSTRACT

The invention provides passive aerating apparatus for accelerating the breathing or aerating process of a liquid such as wine in a vessel such as a decanter. The passive aerating apparatus comprises a gas permeable portion formed in a sidewall of the vessel. The gas permeable portion is composed of silicone, silicone hydrogel, silicone-acrylate or fluoro-silicone-acrylate. The vessel may further or alternatively be configured to substantially block ultraviolet light.

### FIELD OF INVENTION

This invention generally relates to liquid vessels, and more particularly to wine decanters.

### BACKGROUND OF INVENTION

Liquid vessels such as wine decanters are generally known. A typical glass wine decanter is used to retain wine poured from a bottle in a decanting process in which any wine sediment is left in the bottom of the bottle. Wine decanters are also considered a means of allowing wine to “breathe” through exposure to air or through aerating. Such breathing or aerating of wine between opening and serving has long been recognized as a means of improving the taste, aroma, and appearance of certain wines. Various wines require different breathing periods, but many are typically allowed to breath for at least several hours. Thus, varying wine decanters designs are available, in particular with varying neck opening and body diameters depending on the time that the wine is to be allowed to breath prior to serving.

Various mechanical means have been proposed to shorten the breathing period by actively accelerating the breathing process through aeration. Such devices typically operate by mixing oxygen into the wine by pouring or stirring the wine or by percolating air through the wine. For example, known devices include simple agitators or pour-over fitments inserted into the neck of the bottle or decanter during pouring. More complex mechanical systems include air pumps, air percolators, cycling bottle inverters, and perforated baffles within the decanter, to name just a few. Vigorous bubbling or mixing or other active mechanical means of accelerating the breathing process are considered by many to adversely affect the taste, aroma, appearance, or other characteristics of wine. Similarly, ultraviolet light may adversely affect various characteristics of wine.

Accordingly, there exists a need for passive means for accelerating the breathing process of liquids within vessels such as wine within wine decanters. Similarly, a need exists for protecting wine or other liquids from ultraviolet light during storage and shipping.

### SUMMARY OF INVENTION

While the way that the present invention addresses the disadvantages of the prior art will be discussed in greater detail below, in general, the present invention provides a passive aerating apparatus for accelerating the breathing process of liquids within a vessel, such as wine within a decanter. An exemplary passive aerating apparatus includes a gas permeable portion of a vessel sidewall. In the exemplary context of a wine decanter, the present invention includes a vessel sidewall having a gas permeable portion in contact with liquid contents on the interior and ambient air on the exterior.

In various embodiments, the gas permeable portion of the vessel sidewall comprises silicone-acrylate or fluoro-silicone-acrylate. In some embodiments, the gas permeable portion may comprise only a small portion of the sidewall. In other embodiments, to maximize oxygen exchange, the gas permeable portion may extend from the vessel base to at least the surface of the liquid contents of the vessel. Accordingly, the liquid contents of a vessel are exposed to oxygen or another gas by means of a gas permeable portion of the vessel sidewall. The vessel sidewall may further or alternatively be configured to substantially block ultraviolet light.

### BRIEF DESCRIPTION OF THE DRAWINGS

A more complete understanding of the present invention may be derived by referring to the detailed description and claims when considered in connection with the Figures, wherein like reference numerals refer to similar elements throughout the Figures, and

FIG. 1 illustrates an exemplary gas permeable vessel according to one embodiment having a portion of the vessel sidewall formed from a gas permeable material;

FIG. 2 illustrates an exemplary gas permeable vessel according to another embodiment wherein the gas permeable portion of the vessel sidewall extends from the vessel base to the surface of the liquid contents; and

FIG. 3 illustrates an exemplary gas permeable vessel according to another embodiment wherein the entire vessel sidewall is formed from a gas permeable material and/or ultraviolet-blocking material.

### DETAILED DESCRIPTION

The following description is of exemplary embodiments of the invention only, and is not intended to limit the scope, applicability or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, transport mechanisms and the like and still fall within the scope of the present invention. Thus, the detailed description herein is presented for purposes of illustration only and not of limitation.

In accordance with various aspects of the present invention, a vessel for holding liquids includes a gas permeable portion formed in a sidewall of the vessel. The present invention may be used to increase the exposure of any vessel contents to gases present in the environment surrounding the container. That being said, the present invention is described herein in the exemplary context of a wine decanter, though those skilled in the art will appreciate that other liquids or materials for which exposure to gases and/or protection from ultraviolet light is desirable may likewise be substituted in the context of the present invention. Similarly, “decanter” as used herein, generally may be construed to mean any vessel capable of holding a material.

The terms vessel and decanter, as used herein, include any container, bottle, reservoir, carafe, Petri dish, vial, or the like suitable for retaining, storing, shipping, or transporting a liquid. Suitable decanters may be of any shape or size and in general, include a base, a continuous sidewall extending upwardly from the base, and a neck or opening defined by the upper portion of the sidewall. In various embodiments, the base supports the decanter, while in other embodiments, the decanter is suspended by a rim, neck, or other feature. In various embodiments, the decanter may further include a closure or other fitment associated with the decanter opening. The top surface of the liquid contents of the decanter is exposed to the ambient air (e.g., oxygen) with passive gaseous exchange or exposure at the surface varying depending, among other factors, on the internal dimensions of the sidewall and opening.

In accordance with the present invention, additional passive gaseous exchange or exposure is provided by a gas permeable portion formed in the sidewall of the decanter. In one embodiment, only a small portion of the sidewall comprises a gas permeable material, while in various other embodiments, the gas permeable portion extends from the base to at least the surface of the liquid contents. In another embodiment, the gas permeable portion extends the full height of the sidewall and/or comprises the entirety of the decanter. Any number of gas permeable materials or gas permeable portions may be used in accordance with the present invention. The gas permeable portion of the sidewall may be formed separately from the rest of the decanter body and then attached thereto by a bonding agent, fastener, interference fit, or the like. Alternatively, the gas permeable portion may be integrally formed with the decanter body.

That being said, a gas permeable portion may be formed from any gas permeable material having a suitable oxygen permeability, such as, for example, silicone, silicone hydrogel, silicone-acrylate and fluoro-silicone-acrylate materials. The gas permeable material may be selected and the sidewall portion configured to achieve a specified oxygen permeability (Dk). In various embodiments, for example, it may be advantageous to utilize a material having a minimum oxygen permeability of 10 Dk. Exemplary available gas permeable materials include Kolfocon A-C (Dk 18-54), Sterafocon A (Dk 30), PERM 15 (Dk 15), Pemufocon A (Dk 25), FSA-30 (Dk 30), FSA-60 (Dk 60), FSA-90 (Dk 90), FSA-151 (Dk 151), Oxyflufocon A (Dk 60), PERM F40 (Dk 40), HS-40 (Dk 40), HS-56 (Dk 56), Filofocon A (Dk 40), Onsifocon A (Dk 56), Wilofocon A (Dk 27), and Hofocon A (Dk 97). The general principles of oxygen transport through silicone-containing polymers are generally known in the art, and therefore, are not addressed here.

Any such materials may be readily altered by varying the ratios of silicone monomer or other material components. Any number of material additives may also be used in accordance with the present invention. For example, fillers, tints, dyes, reinforcing microfibers, impact modifiers, antioxidants, heat stabilizers, ultraviolet stabilizers, ultraviolet blockers, and colorant compositions may be used to provide desired mechanical properties. Various materials and components of the decanter may be configured to exhibit a desired impact resistance, tensile strength, ultraviolet absorption, chemical resistance, deposit resistance, transparency, stiffness, chemical resistance, weatherability, oxygen permeability or other mechanical or transport properties.

For example, in various embodiments, the vessel sidewall includes various ultraviolet-blocking additives, ultraviolet-blocking materials, dyes or tints to protect the vessel contents from ultraviolet light as some wines are especially susceptible to adverse impact from ultraviolet light. Similarly, ultraviolet-blocking additives may be used with any type of vessel and any type of vessel contents. The ultraviolet-blocking material may be composed to block UVA, UVB, UVC, and high energy blue light. To provide maximum protection to the vessel contents, it may be advantageous for the ultraviolet-blocking material to be composed so as to block substantially all UVA, UVB, and UVC radiation. Suitable ultraviolet-blocking materials include any ultraviolet-blocking substance that may be dissolved into or bonded to polymers and/or glass. Exemplary ultraviolet-blocking materials include, Uvinul D-49—2,2′-dihydroxy-4,4′-dimethoxybenzophenone. Any suitable ultraviolet-blocking material may be used in accordance with the present invention. In various embodiments, portions of the sidewall are composed of a gas permeable, ultraviolet-blocking material, and in other embodiments, portions of the sidewall are composed of a gas impermeable, ultraviolet-blocking material.

The gas permeable portion may be formed from any suitable material whether in the form of sheeting, pellets, powder, resin, liquid, or the like. The gas permeable material may have a single-phase or multi-phase morphology, may be an alternating block copolymer, or may have any other suitable morphology. The gas permeable portion may by prepared by mechanical blending of the components with conventional mixing equipment and may then be formed by in-mold polymerization using heat or light to activate an initiator. Alternatively, the gas permeable portion may be formed by any known molding process, for example, by heating and shaping a bulk material or by laminating and forming multiple layers together. The gas permeable portion may further undergo plasma treatment, surface machining, or other post-mold surface treatment or manufacturing processes. It is understood that any process now known or later developed for forming a gas permeable or ultraviolet blocking material may be used in accordance with the present invention.

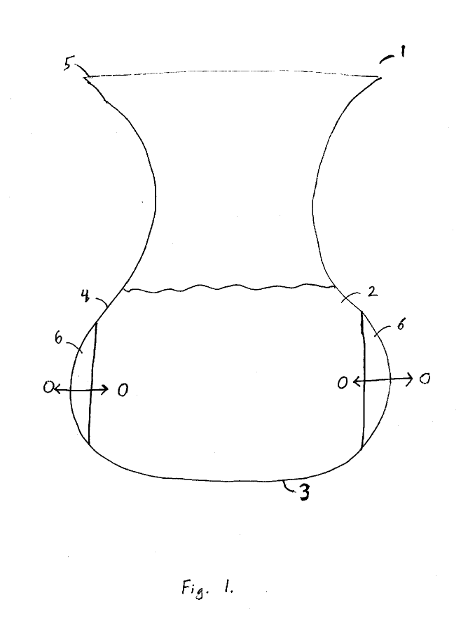

With reference now to FIG.1, an exemplary decanter 1 for aerating a liquid 2, according to one embodiment of the present invention includes a base 3, sidewall 4, neck 5, and a gas permeable portion 6 of sidewall 4. Gas permeable portion 6 serves to transport a gas, such as oxygen, as indicated by the dual arrows and O's, through sidewall 4. Gas permeable portion 6 of sidewall 4 may include a single portion or multiple discrete portions circumferentially spaced around sidewall 4. In an alternative embodiment, gas permeable portion 6 forms a continuous band around decanter 1.

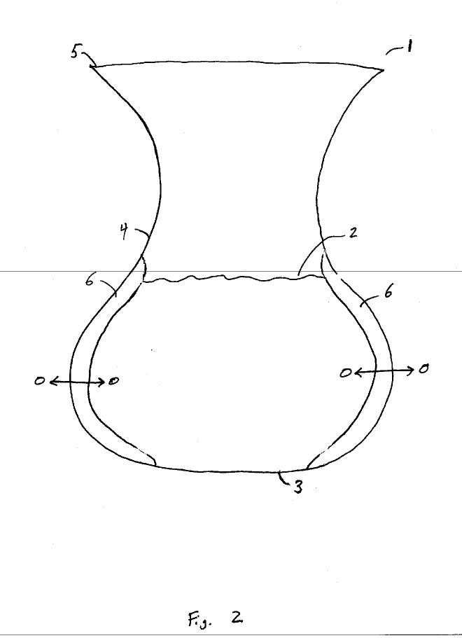

With reference now to FIG. 2, a second exemplary decanter 1 is shown according to another embodiment of the present invention in which gas permeable portion 6 of sidewall 4 extends from base 3 of decanter 1 at least to the surface of liquid 2. This configuration combined with a material having a high oxygen permeability may be advantageous for maximizing oxygen exposure of liquid 2. Gas permeable portion 6 may be configured to transport any number of gases at any desired rate depending on the application and desired transport characteristics.

In one embodiment, gas permeable portion 6 is sufficiently large that the surface area of gas permeable portion 6 that is exposed to the decanter contents is greater than the area of the surface of those contents that is exposed to ambient air within decanter 1. Accordingly, in the context of a wine decanter, it may be advantageous for gas permeable portion 6 to extend from base 3 to the height of the volume of a wine bottle, approximately 700 ml, within decanter 1.

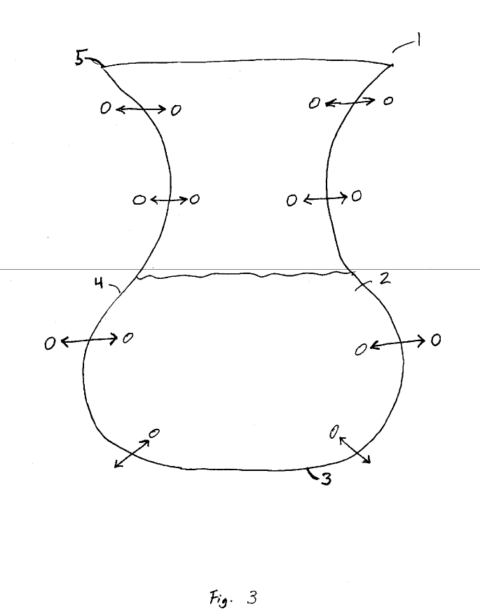

With reference now to FIG. 3, a third exemplary decanter 1 is shown according to another embodiment of the present invention in which gas permeable portion 6 of sidewall 4 extends the full height of sidewall 4. In accordance with one variation of this exemplary embodiment, any number of additional decanter features may be integrally formed of a gas permeable material, including the entirety of sidewall 4 and base 3. Sidewall 4 may be further or alternatively configured to substantially block ultraviolet light so as to reduce any adverse impact of ultraviolet light on liquid 2 or other vessel contents.

While oxygen transport through a gas permeable base 3 of decanter 1 may be stifled when base 3 is in contact with a solid surface, it may be advantageous for other reasons, such as ease and cost of manufacturing, to form base 3 from the same gas permeable material as gas permeable portion 6. Similarly, while little benefit may be provided by any part of gas permeable portion 6 located above the level of liquid 2, it may be advantageous for other reasons, such as ease and cost of manufacturing, to extend gas permeable portion 6 to neck 5 of decanter 1. That being said, in various embodiments, it may desirable for gas permeable portion 6 to include only those portions of sidewall 4 that are exposed to liquid 2 on the interior and ambient air on the exterior.

Accordingly, the present invention provides a passive, gas permeable aerating apparatus for use with liquid vessels. Various alternative embodiments may include accessories such as a handle, stand, removable closure, aerating insert or pour spout, or the like. In one embodiment, a moveable gas impermeable barrier may be associated with the gas permeable portion of the vessel sidewall to meter or stop oxygen transport. Similarly, while the present invention has been described herein as a passive aerating apparatus and means for accelerating the breathing process, the present invention may be readily used with any number of the active mechanical aerators or any number of other similar devices now known or hereafter developed.

Finally, while the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A liquid vessel comprising:
a base; and
a sidewall extending upwardly from said base and defining an opening for receiving liquids, a gas permeable portion of said sidewall comprising a gas permeable material.

2. The vessel of claim 1, wherein said gas-permeable material includes silicone.

3. The vessel of claim 1, wherein said gas-permeable material comprises at least one of a silicone, silicone hydrogel, silicone-acrylate and a fluoro-silicone-acrylate material.

4. The vessel of claim 1, wherein said gas-permeable material exhibits oxygen permeability of at least 10 Dk.

5. The vessel of claim 1, wherein said gas permeable portion of said sidewall extends from said base to a height approximately equal to the level of 700 ml of liquid within said vessel.

6. The vessel of claim 1, wherein said gas permeable portion of said sidewall extends substantially the full height of said sidewall.

7. The vessel of claim 1, further comprising a mechanical aerator associated with said vessel.

8. The vessel of claim 7, wherein said mechanical aerator comprises at least one of a pour spout, pour over fitment, stirrer, mixer, and a submerged air supply.

9. The vessel of claim 1, wherein said sidewall is configured to substantially block ultraviolet light.

10. The vessel of claim 9, wherein said sidewall comprises an ultraviolet-light blocking additive.

11. The vessel of claim 1, wherein said gas permeable portion of said sidewall is configured to contact a retained liquid over a greater area than the area of the surface of the retained liquid that is exposed to ambient air within said vessel.

12. The vessel of claim 1, wherein said base is a non-standing base and said vessel is supported by other than said base.

13. The vessel of claim 1, further comprising a gas impermeable barrier moveable to cover at least part of said gas permeable portion of said sidewall.

14. An improved wine decanter, the improvement comprising:
an oxygen permeable, liquid impermeable aerating apparatus formed in a sidewall of said decanter.

15. The improved wine decanter of claim 14, wherein said oxygen permeable, liquid impermeable aerating apparatus comprises a silicone-containing material.

16. The improved wine decanter of claim 15, wherein said silicone-containing material comprises at least one of silicone, silicone hydrogel, silicone-acrylate and fluoro-silicone-acrylate material.

17. The improved wine decanter of claim 14, further comprising a gas impermeable barrier moveable to cover at least a part of said gas permeable portion of said sidewall.

18. The improved wine decanter of claim 14, wherein said oxygen permeable, liquid impermeable aerating apparatus is configured to contact wine over at least as great of an area as the area of the surface of said wine that is exposed to ambient air within said decanter.

19. The improved wine decanter of claim 14, wherein said oxygen permeable, liquid impermeable aerating apparatus extends from a base of said decanter to approximately the full height of said decanter.

20. Avessel comprising:
a base; and
a sidewall extending upwardly from said base and defining an opening, a portion of said sidewall comprising at least one of glass and a polymer and further comprising an ultraviolet-blocking additive.

21. The vessel of claim 20, further comprising a gas permeable portion of said sidewall comprising a gas permeable material.

22. The vessel of claim 20, wherein said gas-permeable material comprises at least one of a silicone, silicone hydrogel, silicone-acrylate and a fluoro-silicone-acrylate material.
